(19) United States
(12) Patent Application Publication
(10) Pub. No.: US 2004/0114867 A1
(43) Pub. Date: Jun. 17, 2004

(54) Tunable micro-ring filter for optical WDM/DWDM communication

(76) Inventors: Matthew Nielsen, Schenectady, NY (US); Min-Yi Shih, Niskayuna, NY (US); Samhita Dasgupta, Niskayuna, NY (US)

Correspondence Address: GENERAL ELECTRIC COMPANY, GLOBAL RESEARCH, PATENT DOCKET RM. BLDG. K1-4A59, SCHENECTADY, NY, 12301-0008, US

(21) Appl. No.: 10/320,545

(22) Filed: Dec. 17, 2002

(51) Int. Cl. G02B 6/26; G02B 6/42

(52) U.S. Cl. 385/40

(57) ABSTRACT

A technique for implementing a tunable micro-ring filter is disclosed. According to an embodiment of the present invention, a tunable filter for optical communication systems comprises a first waveguide forming a pattern with a second waveguide; a resonator coupled to the first waveguide and the second waveguide wherein the resonator comprises a nonlinear optical material; an electrode structure sandwiching the first waveguide, the second waveguide and the resonator; the electrode structure adapted for receiving a tuning signal and tuning an effective index of the resonator in response to the tuning signal; and a substrate supporting the first waveguide, the second waveguide, the resonator and the electrode structure.

### BACKGROUND OF THE INVENTION

The invention relates generally to micro-ring filters and, more particularly, to a technique for implementing a tunable micro-ring filter for optical Wavelength Division Multiplexing (WDM)/Dense Wavelength Division Multiplexing (DWDM) communication systems.

For optical networks, various multiplexing schemes may be employed (e.g., WDM, ultra-dense WDM, etc.) to increase transmission bandwidth by simultaneously transmitting data from a plurality of sources to a plurality of destinations over an optical medium. Generally, data from the plurality of sources may be intended for multiple different destinations. Therefore, it is necessary to selectively switch and route various data to a plurality of intended destinations, using filters, switches, couplers, routers, and/or other devices. An optical signal generally includes a plurality of wavelengths where each wavelength may represent data from a plurality of different sources. An optical network should be able to direct each wavelength (e.g., each separate data source), separate from the other wavelengths, over various paths in the network. Switching and/or filtering functions facilitate routing of a desired wavelength to an intended destination and further facilitate rerouting in case of network (or other) failure thereby alleviating network congestion.

Wavelength add/drop filters are a common component in current optical WDM/DWDM communication systems. A planar dispersive element is usually required to fabricate DWDM elements in a chip-size photonic circuit. Channel dropping filters that access one channel of a DWDM signal and do not disturb the other channels are important for DWDM communication. Resonant filters are an attractive candidate because these filters can potentially realize a narrow linewidth with large free-spectral range (FSR) for a given device size.

Wavelength add/drop filters allow different wavelengths to be added or removed from an optical transmission line. Add/drop filters may be designed to be switched on and off to add or remove selected wavelengths from a transmission line and may further be designed to be tunable, e.g., single devices may be designed to add or remove any one of a number of different wavelengths. Current filters, such as array waveguide grating (AWG) structures, suffer from a variety of physical limitations, such as high crosstalk, frequency insensitivity, and overall large size, which makes some filters unsuitable for large scale integration.

It is generally very difficult to tune and reconfigure current optical WDM/DWDM communication systems due to the complexity of the overall system and difficulty in realizing appropriate structures to produce the necessary functionality in an optical medium. In addition, stability is oftentimes difficult to maintain in these communication systems. Current technology has not demonstrated a solution to effectively tune a micro-ring filter structure. Passive micro-ring filters are imposed with strict constraints on the fabrication process by the resonant nature of the cavity and its temperature sensitivity which lead to difficulty in obtaining precision and uniformity necessary to implement optical integrated circuits. Furthermore, to maintain stability and to reconfigure current optical WDM/DWDM communication systems usually require a very costly and complicated design.

For ultra high-speed communications, optical or photonic systems are usually required or at least preferred. However, certain electronic elements in the system limit the speed at which these systems operate. Furthermore, current optical or photonic solutions are bulky, costly and complicated with limited specifications. As a result, only limited all-optical solutions have been brought to photonic communication applications. Certain materials such as silica and semiconductors have been implemented in micro-resonator concepts due to their ease of fabrication and relative optical qualities (e.g., high index). However, these materials generally possess low nonlinear optical coefficients and are not sufficient for compact designs, such as tunable micro-resonators.

These and other drawbacks exist in current systems and techniques.

### BRIEF DESCRIPTION OF THE INVENTION

In accordance with an exemplary aspect of the present invention, a tunable filter for optical communication systems comprises a first waveguide forming a pattern with a second waveguide; a resonator coupled to the first waveguide and the second waveguide wherein the resonator comprises a nonlinear optical material; an electrode structure sandwiching the first waveguide, the second waveguide and the resonator; the electrode structure adapted for receiving a tuning signal and tuning an effective index of the resonator in response to the tuning signal; and a substrate supporting the first waveguide, the second waveguide, the resonator and the electrode structure.

In accordance with another exemplary aspect of the present invention, an all-optical tunable filter for optical communication systems comprises a first waveguide receiving an input signal; a second waveguide performing a filtering function, wherein the second waveguide forms a pattern with the first waveguide; a resonator coupled to the first waveguide and the second waveguide wherein the resonator comprises a nonlinear optical material; the resonator adapted to tune an effective index of the resonator; and a substrate supporting the first waveguide, the second waveguide and the resonator.

Aspects of the present invention will now be described in more detail with reference to exemplary embodiments thereof as shown in the appended drawings. While the present invention is described below with reference to preferred embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is an example of a tunable micro-ring filter in accordance with an embodiment of the present invention.

FIG. 2 is another illustration of a tunable micro-ring filter with additional electrodes for electro-optical or thermal tuning in accordance with an embodiment of the present invention.

FIG. 3 is a cross-sectional illustration of a tunable micro-ring filter in accordance with an embodiment of the present invention.

FIG. 4 is an example of self-filtering in an all-optical filter according to an embodiment of the present invention.

FIG. 5 is an example of controlled filtering in an all-optical filter according to an embodiment of the present invention.

FIG. 6 is an example of an all-optical filter with self-filtering capabilities in accordance with an embodiment of the present invention.

FIG. 7 is another example of an all-optical filter with self-filtering capabilities in accordance with an embodiment of the present invention.

FIG. 8 is an example of an all-optical filter with controlled filtering capabilities, in accordance with an embodiment of the present invention.

### DETAILED DESCRIPTION OF EXEMPLARY EMBODIMENTS

An aspect of the present invention is directed to a wavelength add/drop filter implemented in optical WDM/DWDM communication systems. Resonant filters, such as micro-ring, micro-disk, and micro-sphere, for channel adding and dropping may be integrated with planar light wave circuits. According to an embodiment of the present invention, tunable micro-ring (micro-disk, micro-sphere or other similar structure) filters may include integrated patterned electrodes. The micro-ring filters may be fabricated by organic or inorganic nonlinear optical materials, such as electro-optic active materials, for example. As a result, an effective index of these micro-ring filters may be tuned when a tuning signal (e.g., an external electrical field or temperature change) is applied to the patterned electrodes. In an embodiment of the present invention, a polymer-based approach is provided where particular nonlinear optical (NLO) dopants, such as Azo-dyes and liquid crystals, are utilized thereby enabling tunability and advanced performances. While applying different voltages across the patterned electrodes, the effective index of the micro-ring filter may be altered, as well as that of the channel. As a result, an output wavelength of the filter of the present invention may be tuned.

According to another aspect of the present invention, an all-optical tunable micro-ring filter comprising a NLO material may be used for filtering purposes which may be achieved by self-filtering or controlled filtering. These micro-rings may be fabricated using organic or inorganic nonlinear optical materials. According to an embodiment of the present invention, an effective index of the all-optical micro-ring filters may be tuned with an optical source. This design provides a compact footprint and a low power budget for high-speed communication applications.

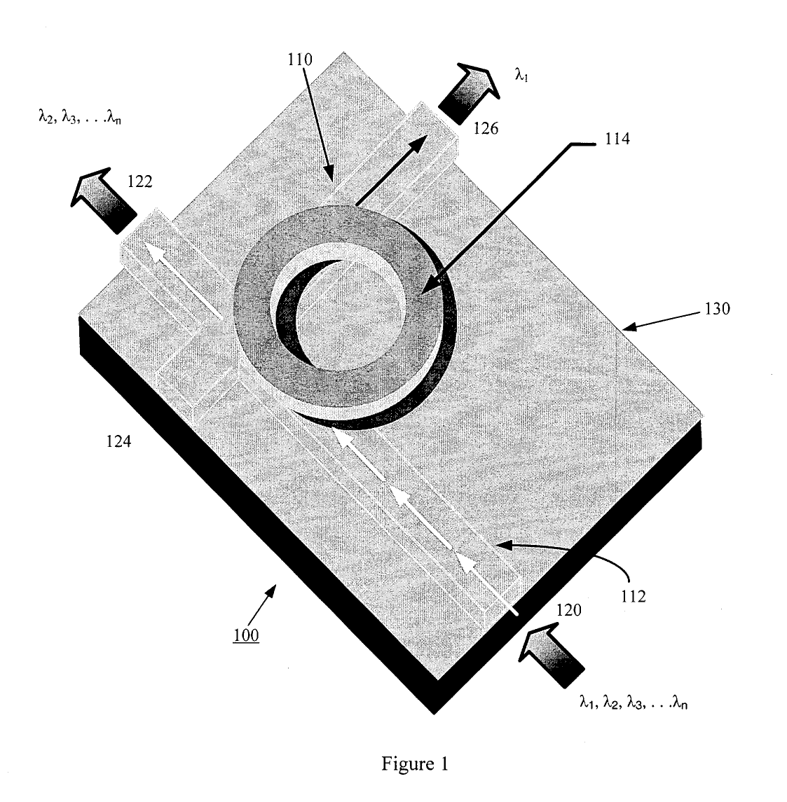

FIG. 1 is an example of a tunable micro-ring filter 100 in accordance with an embodiment of the present invention. Micro-ring devices are generally facet-free resonant cavities that may be conveniently coupled to a waveguide structure to provide compact high spectral resolution filtering and routing capabilities to photonic integrated circuits. In the example of FIG. 1, substrate 130 supports single mode waveguides 110 and 112. While a cross configuration is shown, other configurations may be implemented. Single mode waveguide 112 may have an input port 120 and a throughput port 122. In the example of FIG. 1, input port 120 may receive wavelengths λ₁, λ₂, λ₃, . . . λₙ. Single mode waveguide 110 may have an add port 124 and a drop port 126. In this example, λ₁ is dropped at drop port 126. As a result, wavelengths λ₂, λ₃, . . . λₙ are transmitted at throughput port 122. In another example, a wavelength λ may be added to add port 124 for transmission via throughput port 122. Single mode waveguides 110 and 112 may support a micro-ring resonator 114. In particular, micro-ring resonator 114 may be coupled to waveguides 110 and 112, as shown in FIG. 1. While a ring configuration is shown, other shapes and variations, such as micro-disks and micro-spheres, may be implemented.

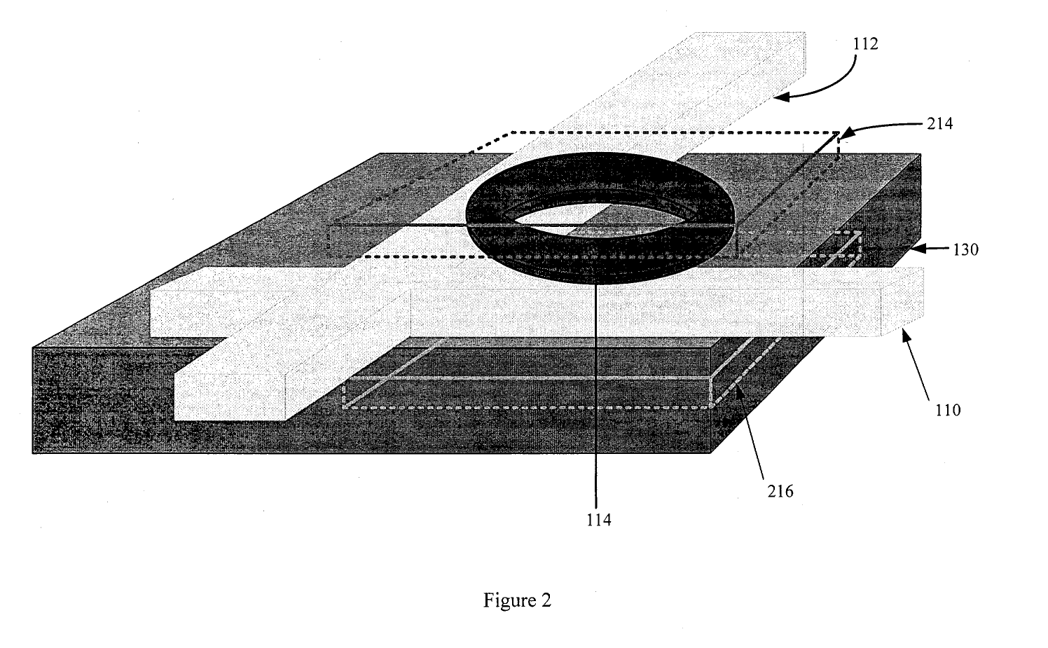

As shown in FIG. 2, a top patterned electrode 214 and a bottom patterned electrode 216 may sandwich the single mode waveguides and the micro-ring resonator. The micro-ring resonator (e.g., micro-disks, micro-spheres or other similar structure) may be fabricated with NLO materials, such as electro-optic, optical, or thermal-optical active materials. In addition, NLO materials may include polymers, doped glasses and semiconductors, for example. The refractive index of the NLO material changes with an application of a tuning signal. In other words, the effective refractive index of the micro-ring filter may be tuned by the tuning signal. The tuning signal may include an external electrical field applied to an electrode structure (e.g., a pair of patterned electrodes) as well as a temperature change generated by an electro/heat source applied to the electrode structure. In the case of a tuning signal including a change in temperature, the size and/or shape of the micro-resonator filter may be altered in response. For example, with a change in temperature, the NLO material may cause the micro-resonator filter to expand, shrink and/or alter in shape.

According to one example, a particular wavelength λ may be dropped via drop port 126 by appropriately changing the effective index of the micro-ring resonator 114, thereby filtering an intended wavelength ?. In addition, the tunability of micro-ring resonator 114 further enhances the adding of a wavelength λ via add port 124. By tuning the micro-ring resonator 114 to a desired effective index (or other property), a wavelength λ added to port 124 will properly transmit via throughput port 122, rather than transmit directly through via drop port 126. The electrodes 214 and 216 may be fabricated using conducting materials. An external electronic control may generate and control the tuning signal. According to one example, the electrical field and the temperature change may be switched on and off through an external electronic control.

According to another embodiment of the present invention, the micro-ring resonator may include a piezo material. Piezo materials may include crystals, insulators, semiconductors, polymers and hybrid materials, for example. Hybrid materials may include embedding a crystal, insulator and/or semiconductor material into a polymer material. Other combinations and materials may be used. The refractive index of the material may be changed in response to a tuning signal. For example, the tuning signal may include a voltage signal for altering the refractive index of the piezo material. The tuning signal may also alter the size and/or shape of the micro-ring resonator. For example, the micro-ring resonator may shrink or expand in response to the voltage signal. In addition, the micro-ring resonator may be changed in shape involving some level of distortion in shape, dimension and/or size.

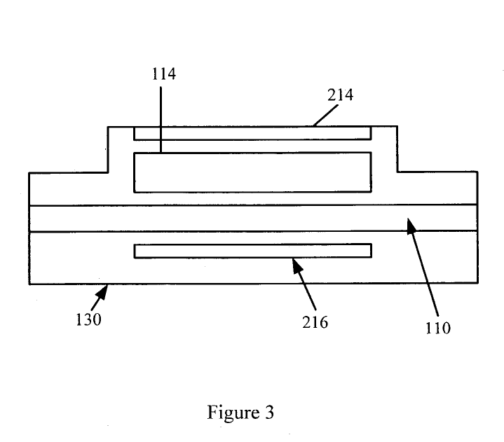

FIG. 3 is another illustration of a tunable micro-ring filter in accordance with an embodiment of the present invention. FIG. 3 is a side-view of the tunable micro-ring filter. As shown, micro-ring resonator 114 is supported by passive waveguide core 110, which may include one or more single mode waveguides. Micro-ring resonator 114 may include an active waveguide core while single mode waveguides may include a passive waveguide core. Substrate (or cladding) 130 supports a top patterned electrode 214 and a bottom patterned electrode 216, which further sandwiches micro-ring resonator 114 and single mode waveguide(s), represented by 110.

As shown in FIG. 2 and FIG. 3, two crossed planar single mode waveguides and a micro-ring resonator may be fabricated by nonlinear optical material which may be sandwiched between a top patterned electrode and a bottom patterned electrode. Various electrode structures may be implemented. For example, an electrode (e.g., top electrode or bottom electrode) may include a plurality of electrodes, forming an electrode structure. While applying a differential voltage across the electrodes, an effective index of the micro-ring may be altered, as well as that of the channel. Thus, an output wavelength of the filter may be tuned. In addition, the tunable filter may be used for maintaining the stability of current optical WDM/DWDM communication systems. For example, by combining the tunability of these micro-ring/disk filters and environmental sensors and/or feedbacks, a tuning signal (e.g., an electric field or a thermal management) may be applied to the tunable micro-ring to maintain the functionality and provide stability of the device.

The tunability, compact and energy efficient design may minimize or eliminate problems of current complicated and costly systems as well as provide additional features such as stability and reconfigurability. The tunability of using electro-optic active materials and patterned electrodes for micro-ring resonators (or other resonator structure, such as micro-disk, micro-sphere, etc.) for optical WDM/DWDM applications provide advantages in tunability, maintenance of stability, and/or reconfiguration of current optical WDM/DWDM communication systems. The design of an embodiment of the present invention also provides a compact footprint and low power budget. Conventional devices, such as AWGs, are usually one to several inches long and few inches wide. For micro-ring resonators, a ring diameter may be in the range of tens to hundreds of micrometers (e.g., a ring-width of approximately 10 micrometers and a ring-thickness of approximately 10 micrometers). Therefore, for the same function of 32 channels (e.g., wavelengths), the footprint of an AWG will be about 2×5 inches while the footprint of 32 micro-ring resonators (one ring for one wavelength) will be within approximately 100×3200 micrometers, which is far more compact. In addition, the size of micro-ring resonators may be determined by various parameters, such as an index contrast between core/cladding materials, loss caused by the bends (e.g., radius), coupling condition between waveguide and micro-ring resonator, as well as other parameters. Generally, the higher the index contrast, the smaller the ring. Also, the design including the distance and the overlapping length between waveguide and micro-ring resonator may be determined for sufficient coupling. Aspects of various embodiments of the present invention will extend and enhance the applications of current optical communication systems for fiber-to-home and other systems.

According to another embodiment of the present invention, an all-optical tunable micro-ring filter comprising a nonlinear optical (NLO) material may be used for filtering purposes which may be achieved by self-filtering or controlled filtering. These micro-rings may be fabricated using organic or inorganic nonlinear optical materials such as Kerr active materials. Kerr materials may include materials whose refractive index changes when optical energy is applied (e.g., index change by an applied optical intensity). According to an embodiment of the present invention, an effective index of the all-optical micro-ring filters may be tuned with an optical source providing optical intensity (e.g., Kerr Effect). In addition, other properties of the all-optical micro-ring filter may be tuned. This design provides a compact footprint and a low power budget for high-speed communication applications.

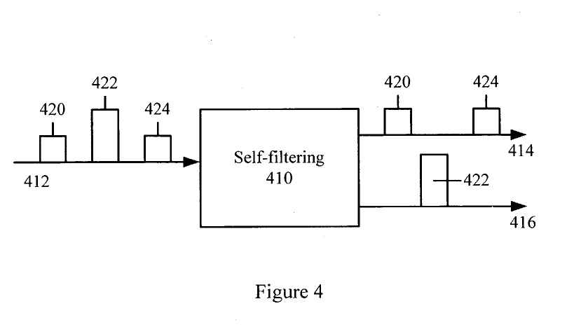

FIG. 4 is an example of self-filtering in an all-optical filter according to an embodiment of the present invention. Self-filtering may be achieved when a high intensity pulse within a signal stream reaches a NLO micro-ring resonator of the present invention. As discussed above, an effective index (or other property) of the micro-ring resonator may be altered by applying optical intensity. As a result, an output wavelength of the filter may be tuned in real time (e.g., when the high intensity pulse is identified). As shown in FIG. 4, a pulse train 412 may be received at an input port. The pulse train 412 may include a plurality of pulses at different intensities, as shown by 420, 422 and 424. Self-filtering may filter out pulses with an intensity above (or below) a predetermined threshold, as detected or identified by the resonator. In this example, pulse 420 and pulse 424 may be transmitted at 414 while pulse 422 with a higher intensity may be filtered at 416. Pulse 420 and pulse 424 may be transmitted via a throughput port while pulse 422 may be filtered via a drop port. In addition, the self filtering functionality of an embodiment of the present invention may be achieved by applying a thermal change.

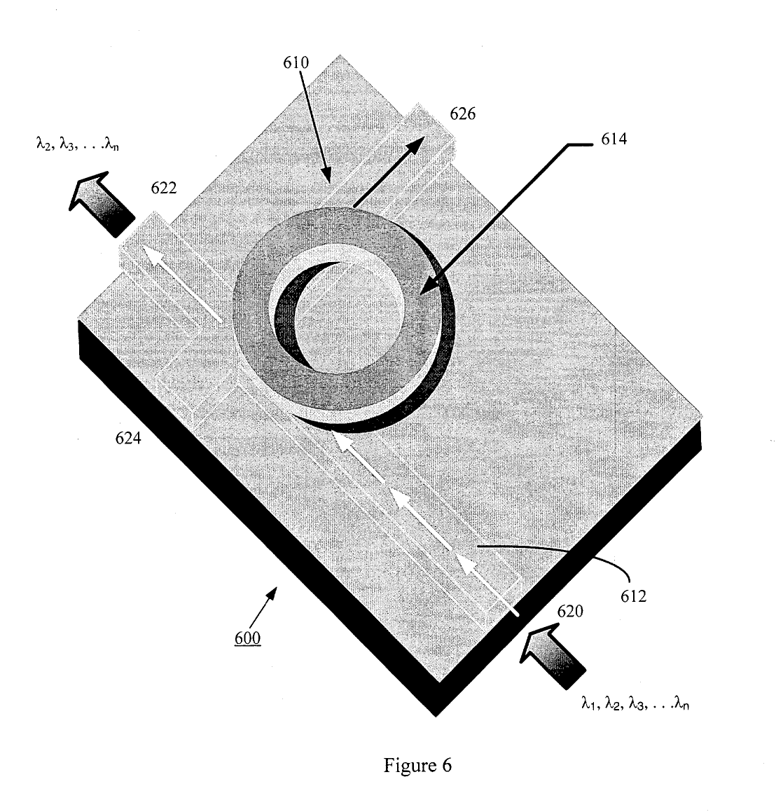

FIG. 6 is an example of an all-optical filter 600 with self-filtering capabilities in accordance with an embodiment of the present invention. Single mode waveguides 610 and 612 support micro-ring resonator 614 where micro-ring resonator 614 may include a NLO material. At an input port 620, a pulse train including a plurality of wavelengths may be received. In this example, a signal at wavelength λ₁ is to be filtered and dropped at drop port 626 onto another waveguide. However, if the intensity of the signal at wavelength λ₁ does not reach a predetermined threshold of the NLO effect as detected or identified by the micro-ring resonator 614, the filtering of wavelength λ₁ will not occur.

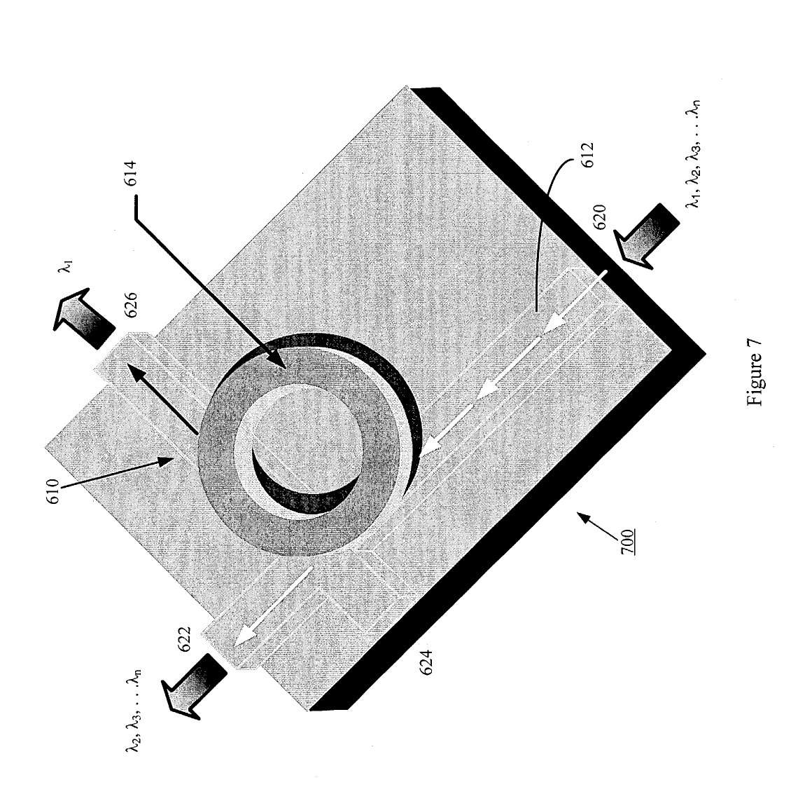

Once the intensity of the signal reaches a predetermined threshold, the signal will be filtered onto a drop port 626, as shown in FIG. 7. FIG. 7 is another example of an all-optical filter 700 with self-filtering capabilities in accordance with an embodiment of the present invention. In FIG. 7, a signal at wavelength λ₁ has an intensity above (or below) a predetermined threshold so that the all-optical filter 700 filters out the signal at wavelength λ₁ by self-filtering where an external optical or electrical field is not applied.

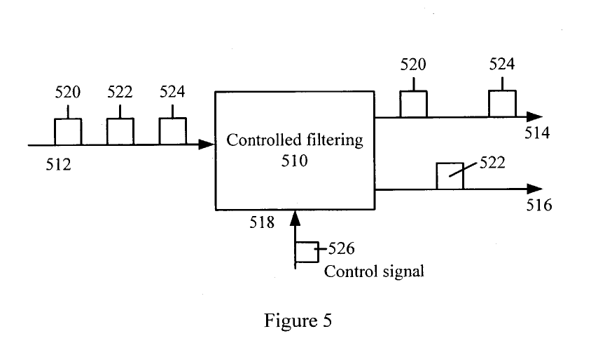

FIG. 5 is an example of controlled filtering in an all-optical filter according to an embodiment of the present invention. In this embodiment of the present invention, a control signal may be used for selecting a particular wavelength to filter via a port (e.g., a drop port). As shown in FIG. 5, a pulse train 512 may be received at an input port. The pulse train 512 may include a plurality of pulses at substantially similar intensities, as shown by 520, 522 and 524. A control signal may be received at 518 via a port (e.g., an add port) where the control signal comprises a pulse 526. In response to the received control signal, pulse 520 and pulse 524 may be transmitted at 514 via a throughput port while pulse 522 is filtered at 516 via a drop port.

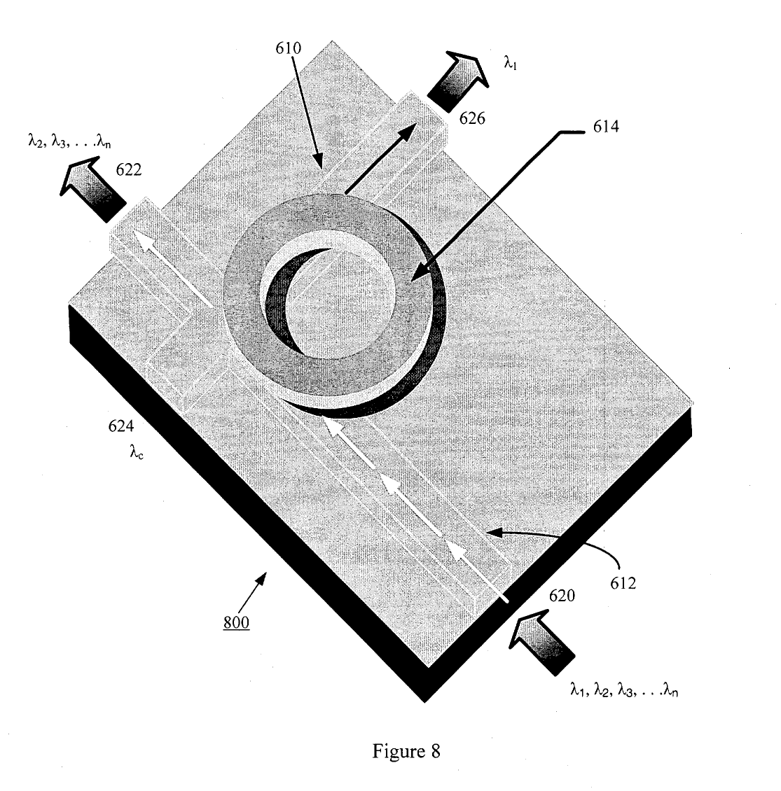

FIG. 8 is an example of an all-optical filter 800 with controlled filtering capabilities, in accordance with an embodiment of the present invention. In FIG. 8, a signal at wavelength λ₁ may be filtered onto a drop port 626. However, without a control signal at wavelength λ₂, a filtering action will not occur. According to an embodiment of the present invention, a control signal λ_{C} may be received at an add port 624 for selectively filtering a particular wavelength, such as λ₁, at a drop port 626. For example, when a high intensity λ_{C} pulse is applied to port 624, the effective refractive index of the micro-ring will be changed (e.g., Kerr effect). This change of index results in filtering a wavelength λ₁ onto drop port 626. The control signal λ_{C} may be intensity based or spectral (e.g., color) based. The control signal may be based on other distinguishing characteristics. For example, based on an intensity associated with the control signal, a particular wavelength received at input port 620 may be dropped at drop port 626. In another example, the micro-ring resonator 614 may be sensitive to ultraviolet (UV) light in which case the control signal may have a particular UV format for selectively filtering a wavelength.

By using a micro-ring/disk structure of the present invention, a large FSR and/or a narrow channel of optical filters may be achieved while improving costs and minimizing footprint. An all-optical filter using NLO materials may further enhance the ability to operate at ultra high-speeds over 100 GHz, for example. By using micro-ring/disk structure, the cost and footprint of optical filters may be reduced dramatically while maintaining and improving the required performances.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1. A tunable filter for optical communication systems, the filter comprising:
a first waveguide forming a pattern with a second waveguide;
a resonator coupled to the first waveguide and the second waveguide wherein the resonator comprises a nonlinear optical material;
an electrode structure sandwiching the first waveguide, the second waveguide and the resonator; the electrode structure adapted for receiving a tuning signal and tuning an effective index of the resonator in response to the tuning signal; and
a substrate supporting the first waveguide, the second waveguide, the resonator and the electrode structure.

2. The filter of claim 1, wherein the tuning signal comprises an electric field.

3. The filter of claim 1, wherein the tuning signal comprises a change in temperature.

4. The filter of claim 1, wherein the first waveguide and the second waveguide both comprise single-mode waveguides.

5. The filter of claim 1, wherein the first waveguide and the second waveguide form a cross pattern.

6. The filter of claim 1, wherein the resonator comprises an electro-optic active material.

7. The filter of claim 1, wherein the resonator is a micro-ring resonator.

8. The filter of claim 1, wherein the resonator is a micro-disk resonator.

9. The filter of claim 1, wherein the electrode structure comprises a first top electrode and a second bottom electrode.

10. The filter of claim 1, further comprising an external electronic control for controlling the tuning signal.

11. An all-optical tunable filter for optical communication systems, the filter comprising:
a first waveguide receiving an input signal;
a second waveguide performing a filtering function, wherein the second waveguide forms a pattern with the first waveguide;
a resonator coupled to the first waveguide and the second waveguide wherein the resonator comprises a nonlinear optical material; the resonator adapted to tune an effective index of the resonator; and
a substrate supporting the first waveguide, the second waveguide and the resonator.

12. The filter of claim 11, wherein the resonator identifies at least one pulse having an intensity above a predetermined threshold and filters the identified at least one pulse.

13. The filter of claim 12, wherein the second waveguide comprises a drop port for dropping the identified at least one pulse.

14. The filter of claim 11, wherein the resonator is adapted to receive a control signal altering the effective index for filtering a wavelength wherein the control signal indicates a wavelength to be filtered.

15. The filter of 14, wherein the control signal is intensity based.

16. The filter of 14, wherein the control signal is spectral based.

17. The filter of claim 11, wherein the resonator comprises an electro-optic active material.

18. The filter of claim 11, wherein the nonlinear optical material comprises a material whose refractive index changes when an optical energy is applied to the resonator.

19. The filter of claim 11, wherein the resonator is a micro-ring resonator.

20. The filter of claim 11, wherein the resonator is a micro-disk resonator.

21. A tunable filter for optical communication systems, the filter comprising:
a first waveguide forming a pattern with a second waveguide;
a resonator coupled to the first waveguide and the second waveguide wherein the resonator comprises a piezo material;
an electrode structure sandwiching the first waveguide, the second waveguide and the resonator; the electrode structure adapted for receiving a voltage signal and tuning an effective index of the resonator in response to the voltage signal; and
a substrate supporting the first waveguide, the second waveguide, the resonator and the electrode structure.
